(19) United States
(12) Patent Application Publication
(10) Pub. No.: US 2005/0246512 A1
(43) Pub. Date: Nov. 3, 2005

(54) Information-processing apparatus and method and program for starting the same

(75) Inventor: Masayuki Inoue, Kawasaki-Shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/116,373

(22) Filed: Apr. 28, 2005

(30) Foreign Application Priority Data
Apr. 30, 2004 (JP) P2004-135903

(51) Int. Cl. G06F 12/00

(52) U.S. Cl. 711/164

(57) ABSTRACT

An information-processing apparatus containing a previously-stored first password includes an input unit, a detachable storage unit, a determining unit, a creating unit, and a storing unit. The determining unit compares an input password input at startup with the first password to determine the input password matches the first password. If the input password is determined not to match the first password, the determining unit determines whether a second password is present in the storage unit. If the determining unit determines that the second password is not present, the creating unit creates the second password. The storing unit stores the created second password in the storage unit.

### CROSS-REFERENCE TO RELATED APPLICATIONS

This application claims the benefit of priority of Japanese Patent Application No. 2004-135903, filed Apr. 30, 2004, the entire contents of which are incorporated herein by reference.

### BACKGROUND

1. Field

The present invention relates to an information-processing apparatus and to a method and program for starting the information-processing apparatus. In particular, the present invention relates to an information-processing apparatus capable of preventing unauthorized access to data stored on a hard disk drive and relates to a method and program for starting the information-processing apparatus.

2. Description of the Related Art

Recently, security management has become increasingly important in information-processing apparatuses, such as personal computers (PCs).

Such an information-processing apparatus is widely available as traditional standalone usage and networked usage.

In addition, it is also fairly common for a single information-processing apparatus to be used by multiple authorized users.

The amount of information that can be handled by one information-processing apparatus is steadily increasing, and in particular, the storage capacity of external storage devices, typified by hard disk drives, is expanding dramatically.

Under these circumstances, various measures against unauthorized use of an information-processing apparatus have been taken.

One such measure is an authentication technique typified by startup password (also known as power-on password) protection.

Startup password protection is a technique that prompts a user to input a password at startup of the information-processing apparatus and compares the input password with a registered password. If the input one does not match the registered one, the power of the information-processing apparatus is turned off, thus preventing unauthorized persons from using the information-processing apparatus.

The authentication method using a startup password can protect the information-processing apparatus from unauthorized use, but it cannot fully exclude unauthorized access to data in the information-processing apparatus.

In other words, if an unauthorized person who failed to pass authentication with the startup password removes a hard disk drive from the information-processing apparatus and installs the hard disk drive in another information-processing apparatus, he/she can read data stored on the hard disk drive.

Jpn Pat. Publication Nos. 11-259369 and 2003-150455 disclose techniques functioning as measures against unauthorized access to data stored on a hard disk drive. The techniques disclosed are that data stored on the hard disk drive is destroyed when an authentication procedure fails a predetermined number of times.

Jpn Pat. Publication No. 11-249966-discloses-a technique for data protection. The technique disclosed is that a hard disk drive password (HDD password) stored on a nonvolatile memory included in a hard disk drive does not allow a person to read data stored on the hard disk drive unless the person passes an authentication procedure with the HDD password, even if the person removes the hard disk drive, installs it in another information-processing apparatus, and starts it up.

Destroying data stored on the hard disk drive is the most effective way to prevent unauthorized use of a person who failed an authentication procedure with the startup password.

This measure, however, requires making backup copies of the data stored on the hard disk drive onto a server or a removable recording medium, such as a compact disc read-only memory (CD-ROM), constantly. This requirement may become burdensome to an authorized user.

In contrast, protecting data stored on the hard disk drive by an authentication procedure with an HDD password can prevent an unauthorized person, who does not know the HDD password, from gaining access to data in the hard disk drive without destroying the data.

Hard disk drives, which are installed in many modern information-processing apparatuses, mostly conform to the advanced technology attachment (ATA) standard established by the American National Standards Institute (ANSI) for connecting hard disk drives with information-processing apparatuses. The ATA standard includes requirements regarding HDD passwords.

However, information-processing apparatuses having security measures based on HDD passwords are not very popular, except for information-processing apparatuses designed for business use.

One reason is due to a cumbersome task of inputting an HDD password in addition to inputting a startup password.

Another reason is that a method for resetting the HDD password when a user forgets the HDD password is not provided to the public. In other words, the user cannot have access to data stored on the hard disk drive when he or she forgets the HDD password.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is an external view of an information-processing apparatus according to an embodiment of the present invention;

FIG. 2 is a block diagram showing the system configuration of the information-processing apparatus according to an embodiment of the present invention;

FIG. 3 is a block diagram of components relating to a startup process in the information-processing apparatus;

FIG. 4 is a flowchart of the startup process in the information-processing apparatus according to a first embodiment of the present invention;

FIG. 5 is a flowchart of an authentication procedure with an HDD password in the information-processing apparatus according to the first embodiment;

FIG. 6 is a flowchart of an authentication procedure with an HDD password in the information-processing apparatus according to a second embodiment; and

FIG. 7 is a flowchart of an authentication procedure with an HDD password in the information-processing apparatus according to a third embodiment.

### DETAILED DESCRIPTION

An information-processing apparatus and a method and program for starting the information-processing apparatus according to preferred embodiments of the present invention are described below with reference to the drawings.

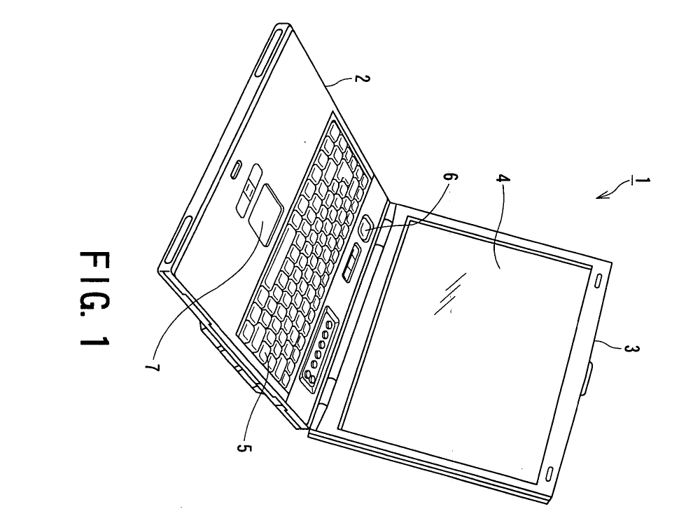

FIG. 1 is an external view of an information-processing apparatus 1 according to an embodiment of the present invention.

The information-processing apparatus 1, typified by a personal computer, includes a low-profile rectangular main body 2 and an openable and closable panel 3 connected to the main body 2.

The panel 3 includes a display unit 4 composed of, for example, a liquid crystal display (LCD).

An input unit 5, such as a keyboard, for inputting various kinds of information and a pointing device 7 for indicating a specific position on the display unit 4 are disposed on the top of the main body 2.

The size and shape of the information-processing apparatus 1 in the present invention is not limited to that shown in FIG. 1. Similarly, the arrangement, size, and shape of each component, including the display unit 4 and the input unit 5, is not limited to that shown in FIG. 1.

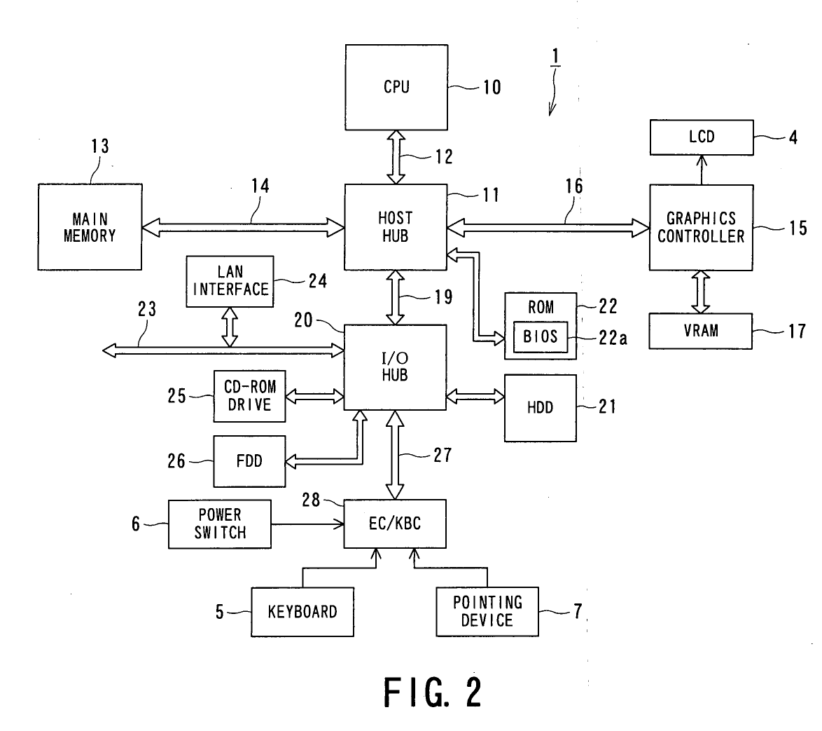

FIG. 2 is a block diagram showing the system configuration of the information-processing apparatus 1 according to an embodiment of the present invention.

A central processing unit (CPU) 10 performing information processing and control of the information-processing apparatus 1 is connected to a host hub 11 via a CPU bus 12.

The CPU 10 runs an operating system (OS) and various application/utility programs loaded to a main storage 13 from a hard disk drive (HDD) 21 (detachable storage unit) serving as an external storage device via an input/output (I/O) hub 20, the host hub 11, and a memory bus 14.

The host hub 11 is connected to devices requiring high-speed processing. Specifically, the host hub 11 is connected to the main storage 13 via the memory bus 14, and to a graphics controller 15 via, for example, an accelerated graphic port (AGP) bus 16.

The host hub 11 is also connected to a basic input output system (BIOS) read-only memory (ROM) 22.

The host hub 11 is also connected to the I/O hub 20 via a bus 19, such as a hub interface.

The I/O hub 20 is connected to the HDD 21, serving as an external storage device.

The I/O hub 20 is also connected to other external storage media, such as a CD-ROM drive 25 and a floppy disk drive (FDD) 26.

The I/O hub 20 is also connected to a peripheral component interconnect (PCI) bus 23. The PCI bus 23 is connected to a device conforming to the PCI bus standard. The device is, for example, a local area network (LAN) interface 24 shown in FIG. 2. The LAN interface 24 is connected to a LAN and/or the Internet if needed.

The I/O hub 20 is also connected to a low pin count (LPC) bus 27, which is used for relatively low-speed processing. The LPC bus 27 is connected to, for example, an embedded controller/keyboard controller (EC/KBC) 28, which is an embedded processor. The EC/KBC 28 is connected to the input unit 5, the pointing device 7, a power button 6, and the like.

The EC/KBC 28 receives power from, for example, a battery even when the information-processing apparatus 1 is in the off state. This allows a press of the power button 6 to be detected so that a startup sequence of the information-processing apparatus 1 can be started.

The input unit 5 functions as a main input device of the information-processing apparatus 1 and is connected to the EC/KBC 28.

The BIOS-ROM 22 stores a program called a BIOS 22a. The BIOS-ROM 22 is, for example, a flash-memory device.

The BIOS 22a is a program that is executed when the information-processing apparatus 1 is turned on. Unlike other programs, such as an OS and an application software program, stored on an external storage, including the HDD 21, the BIOS 22a is a program capable of changing system settings of the information-processing apparatus 1 by performing a predetermined operation at startup.

The CPU 10 executes the BIOS 22a stored on the BIOS-ROM 22.

The graphics controller 15 displays on the display unit 4 data that is created by an OS and/or an application software program and stored on a video memory 17.

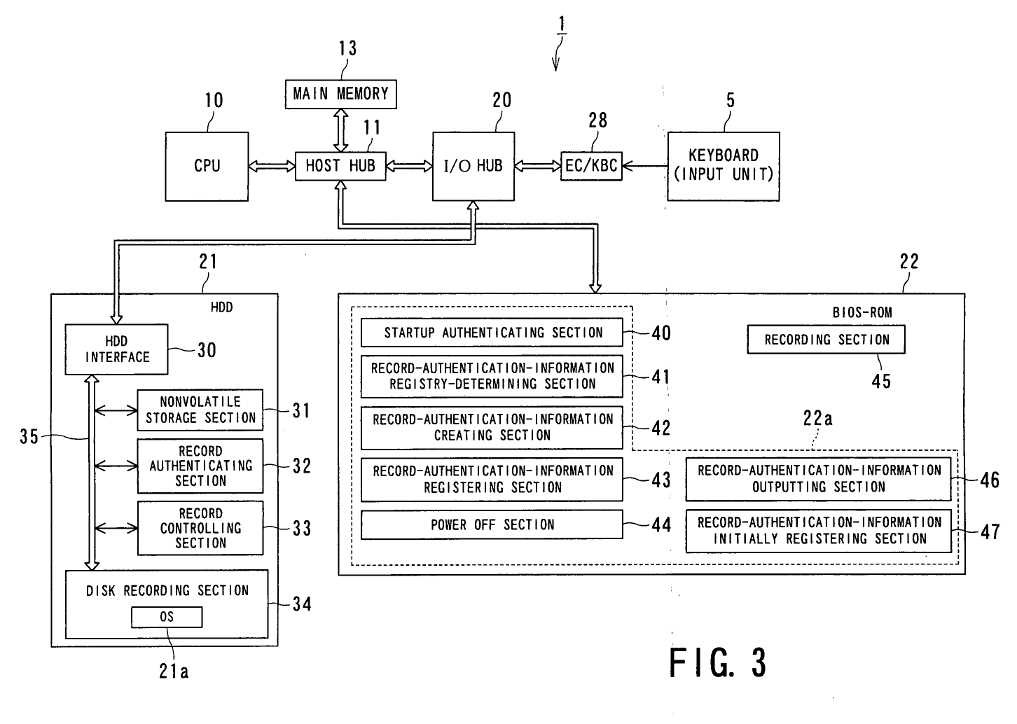

FIG. 3 is a block diagram of components relating to a startup process in the information-processing apparatus 1.

The HDD 21 includes an HDD interface 30 connected to the I/O hub 20. The HDD interface 30 is connected to a disk recording section 34 via an internal bus 35. The internal bus 35 is connected to a nonvolatile storage section 31, a record authenticating section 32, and a record controlling section 33.

The BIOS-ROM 22 includes a recording section 45 capable of recording various kinds of data in addition to the BIOS 22a.

The BIOS 22a includes a startup authenticating section 40, a record-authentication-information registry-determining section 41, a record-authentication-information creating section 42, a record-authentication-information registering section 43, a power-off section 44, a record-authentication-information outputting section 46, and a record-authentication-information initially registering section 47.

The functions of these components are realized by the execution of a program contained in the BIOS 22a by the CPU 10.

The functions of the information-processing apparatus 1 are described below with reference to FIG. 3.

The recording section 45 included in the BIOS-ROM 22 registers startup authentication information, for example, a startup password (a first password). The startup password is capable of being previously registered for the information-processing apparatus 1 by an authorized user. The startup password is registered through the input unit 5 with, for example, a startup password registering section (not shown) included in the BIOS 22a.

Registration of the startup password may be omitted. In this case, the recording section 45 of the BIOS-ROM 22 stores no startup password.

The startup authenticating section 40 (means for authenticating) performs authentication on the basis of the startup password, serving as startup authentication information, at startup of the information-processing apparatus 1. Specifically, it compares an input startup password with a startup password registered in the recording section 45 of the BIOS-ROM 22 to determine whether the input one matches the registered one. If the input startup password matches the registered startup password, authentication is determined to succeed. If not, authentication is determined to fail.

The startup authentication information is not limited to the startup password. The startup authentication information may be token authentication information using a universal serial bus (USB) key or may be biometric authentication information, such as fingerprint identification information.

If the startup authentication succeeds, a person who input the startup password is determined to be an authorized user, and an operating system (OS) 21a stored in the disk recording section 34 of the HDD 21 is started. After the OS 21a is started, an application software program, for example, a word processor program can be started. If a registered HDD password (a second password) for the HDD 21 is present, additional authentication with the HDD password is required.

On the other hand, if the startup authentication fails, a person who input the startup password is determined to be unauthorized, and the following process is performed.

First, the record-authentication-information registry-determining section (means for determining) 41 determines whether a registered HDD password (a second password), serving as record authentication information, is present in the HDD 21. When, for example, the record-authentication-information registry-determining section 41 sends a status determining command to the record controlling section 33 of the HDD 21, the record controlling section 33 returns status information indicating the determination of whether the registered HDD password is present in the nonvolatile storage section 31. The presence of the registered HDD password is determined on the basis of this status information for the HDD 21.

If no registered HDD password is present, the record-authentication-information creating section 42 (means for generating a second password) creates an HDD password.

The record-authentication-information registering section 43 (means for storing) registers the HDD password created by the record-authentication-information creating section 42 in the nonvolatile storage section 31 of the HDD 21. For example, the record-authentication-information registering section 43 sends the HDD password together with a registry command to the record controlling section 33 of the HDD 21. Upon receipt of the registry command, the record controlling section 33 registers the HDD password in the nonvolatile storage section 31.

After the HDD password is registered in the nonvolatile storage section 31, the power-off section 44 (means for turning off) turns off the power of the information-processing apparatus 1.

In this case, the HDD password created by the record-authentication-information creating section 42 has a predetermined relation with the registered startup password.

The predetermined relation may be of any kind as long as the HDD password is uniquely determined from the registered startup password.

Advantages of the information-processing apparatus 1 according to the present invention are described below.

Since an unauthorized person does not know the startup password, he/she fails to pass authentication with the startup password. At this time, for information-processing apparatuses previously proposed, the power is turned off.

In this case, therefore, if no registered HDD password is present in the HDD 21, the unauthorized person can read data stored on the HDD 21 by removing the HDD 21 itself from the information-processing apparatus 1 and installing the removed HDD 21 in another information-processing apparatus that is, for example, owned by the unauthorized person.

On the other hand, according to the present invention, if no registered HDD password is present in the HDD 21, the record-authentication-information creating section 42 can automatically create an HDD password, and then the record-authentication-information registering section 43 can automatically register the created HDD password in the HDD 21.

In addition, since this created HDD password has a unique relation with the startup password unknown to an unauthorized person, he/she inevitably cannot know that HDD password.

If the HDD password previously registered by an authorized user is present, that HDD password is unknown to the unauthorized person.

As a result, even if the unauthorized person installs the HDD 21 in his/her information-processing apparatus, the HDD 21 always retains the HDD password unknown to the unauthorized person, whether or not the authorized user registers the HDD password.

If the registered HDD password is present, access to data stored on the HDD 21 is blocked unless an identical password is input.

In other words, the unauthorized person cannot gain access to the data in the HDD 21.

If the unauthorized person decides not to remove the HDD 21 or if the HDD 21 is removed but returned, the authorized user can gain access to the data stored on the HDD 21.

This is because the HDD password that is automatically registered in the HDD 21 is uniquely determined from the startup password registered by the authorized user, and therefore, the authorized user can know the HDD password.

The record-authentication-information outputting section 46 (means for unlocking protection of a second password) realizes a function of prompting a user to input the HDD password if a registered HDD password is present in the HDD 21 and of outputting to the HDD 21 the HDD password input by the user through the input unit 5.

The record-authentication-information outputting section 46 may automatically create the HDD password to be output to the HDD 21 by means of the BIOS 22a and output the created HDD password to the HDD 21.

The record-authentication-information initially registering section 47 may be included in the BIOS 22a. The record-authentication-information initially registering section 47 realizes a function of automatically creating the HDD password when an authorized user starts up the information-processing apparatus 1 for the first time and of registering the created HDD password in the HDD 21.

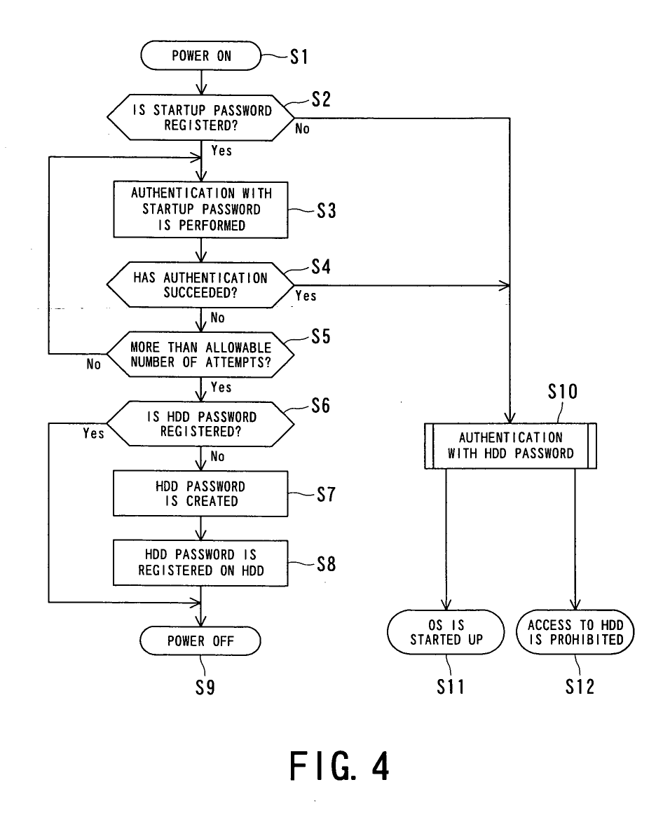

FIG. 4 is a flowchart of processing in the information-processing apparatus 1 according to a first embodiment of the present invention. This processing is carried out by a program contained in the BIOS 22a unless otherwise specified.

After the power of the information-processing apparatus 1 is turned on (step S1 of FIG. 4), the BIOS 22a first determines whether a registered startup password is present in the recording section 45 of the BIOS-ROM 22 (step S2).

If the registered startup password is present (yes in step S2), authentication with the startup password is performed (step S3). In this authentication, for example, the startup password prompt appears on the screen of the display unit 4 of the information-processing apparatus 1, and a user inputs the startup password with, for example, the input unit 5. The processing then moves to step S4.

In step S4, it is determined whether the input startup password matches the registered startup password. If the input one matches the registered one, authentication succeeds (yes in step S4). If not, authentication fails (no in step S4).

In consideration of the possibility of incorrect inputs resulting from misoperation even for an authorized user, the allowable number of attempts to input the correct startup password is preferably set at two or more. For example, after three failed attempts, authentication is determined to fail (yes in step S5).

The function of the startup-authenticating section 40 shown in FIG. 3 is realized by the process of steps S2 to S5 explained above.

The BIOS 22a then determines whether a registered HDD password is present in the HDD 21 (step S6). The function of the record-authentication-information registry-determining section 41 is realized by the process of this step.

If no registered HDD password is present in the HDD 21 (no in step S6), an HDD password that has a unique relation with the registered startup password is created (step S7).

The BIOS 22a then sends the created HDD password for the HDD 21 and a registry command to the HDD 21 (step S8).

The process of step S7 corresponds to the function of the record-authentication-information creating section 42 in FIG. 3, and the process of step S8 corresponds to the function of the record-authentication-information registering section 43 in FIG. 3.

The process of actually registering the sent HDD password in the nonvolatile storage section 31 of the HDD 21 is controlled by the record authenticating section 32 of the HDD 21.

The BIOS 22a then turns the power off (step S9), so that the information-processing apparatus 1 enters the off state.

If the registered HDD password is present in the HDD 21 (yes in step S6), the power is turned off (step S9).

If no registered startup password for the information-processing apparatus 1 is present (no in step S2) or if authentication with the startup password succeeds (yes in step S4), the BIOS 22a performs authentication with the HDD password (step S10).

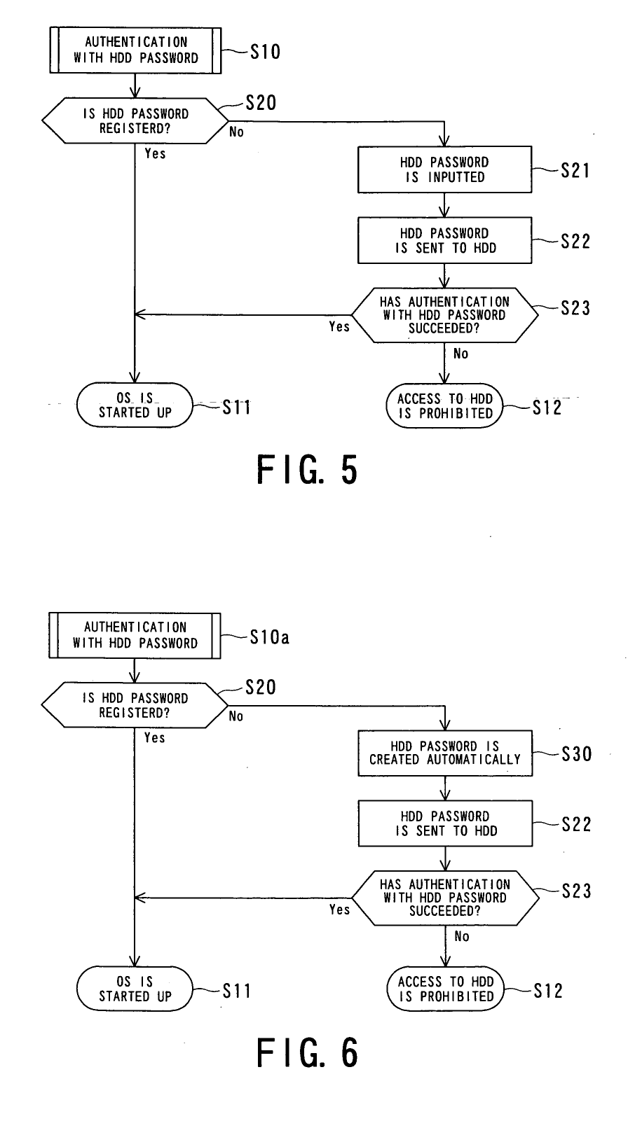

FIG. 5 is a flowchart showing details of an authentication procedure with an HDD password in step S10 shown in FIG. 4.

In step S20 shown in FIG. 5, the BIOS 22a determines whether the registered HDD password is present in the HDD 21. This process is the same as the process of step S6 shown in FIG. 4. In this process, the BIOS 22a sends a status determining command to the HDD 21, and the HDD 21 sends status information indicating the status of the HDD 21 back to the BIOS 22a. The status information regarding the HDD 21 contains the determination of whether the registered HDD password is present.

If no registered HDD password is present (no in step S20), the BIOS 22a starts up the OS 21a. After the OS 21a is started, application software or the like can be started.

On the other hand, if the registered HDD password is present (yes in step S20), the BIOS 22a displays the HDD password prompt on the screen of the display unit 4 of the information-processing apparatus 1, for example. A user inputs the HDD password with, for example, the input unit 5 (step S21).

The BIOS 22a then outputs the input HDD password to the HDD 21 (step S22).

The function of the record-authentication-information outputting section 46 shown in FIG. 3 is realized by the execution of the process of steps S21 and S22.

The HDD 21 compares the HDD password received from the BIOS 22a with the HDD password that is registered in the HDD 21. If the received one does not match the registered one, authentication is determined to fail, and access to data stored on the HDD 21 is prohibited.

On the other hand, if the received one matches the registered one, authentication is determined to succeed, and access to the data stored on the HDD 21 is permitted.

The BIOS 22a then starts up the OS 21a.

There are two ways to register the HDD password in the HDD 21.

The first way is that an authorized user manually registers the HDD password. In this case, the authorized user knows the HDD password, and as a result, he/she can input the correct HDD password in step S21 in FIG. 5.

On the other hand, since an unauthorized person does not know the HDD password that is registered by the authorized user, he/she cannot input the correct HDD password. As a result, he/she fails to pass authentication with the HDD password, and cannot gain access to data stored in the HDD 21.

The second way is that the BIOS 22a automatically creates and registers the HDD password (steps S7 and S8 in FIG. 4) in response to a startup process performed by an unauthorized person.

In this case, since the created HDD password is uniquely determined from the startup password, the authorized user can know the HDD password and input the correct HDD password.

On the other hand, the unauthorized person cannot know the HDD password that is automatically created by the BIOS 22a, thus failing to pass authentication with the HDD password. As a result, he/she cannot gain access to data stored in the HDD 21.

FIG. 6 is a flowchart of an authentication procedure with the HDD password in the information-processing apparatus 1 according to a second embodiment, showing only different processing, i.e., authentication with the HDD password (step S10a), from the processing shown in FIG. 4 illustrating the first embodiment.

The processing shown in FIG. 6 is different from the processing in the first embodiment in that step S21 (of FIG. 5) is replaced with step S30.

In the first embodiment, if the registered HDD password is present, a user inputs the HDD password with the input unit 5.

By contrast, in the second embodiment, if the registered HDD password is present, the BIOS 22a automatically creates a new HDD password (step S30).

The process of creating the HDD password in step S30 is the same as that in step S7 shown in FIG. 4. Therefore, the HDD password that is created in step S30 is identical to the HDD password that is registered in the HDD 21 in step S8 shown in FIG. 4 as long as the information-processing apparatus 1, which is used by an authorized user, is used. As a result, the authorized user can pass authentication with the HDD password.

On the other hand, if another information-processing apparatus, which is different from the information-processing apparatus 1 used by the authorized user, is used, a startup password for this different apparatus differs from the startup password in the information-processing apparatus 1. Since the HDD password created in step S30 is derived from the startup password, the HDD password that is registered in the HDD 21 differs from the HDD password that is created in step S30.

As a result, even if the unauthorized person removes the HDD 21 from the information-processing apparatus 1 and installs it in a different information-processing apparatus, he/she fails to pass authentication with the HDD password.

According to the second embodiment, the same advantages as those in the first embodiment are realized. In addition, the inputting of the HDD password is not required even when the registered HDD password is present, thus enhancing the convenience of authorized users.

In the second embodiment, the HDD password is not manually registered by a user. Only automatic registration of the HDD password (i.e., the processing of step S8 in FIG. 4) is carried out.

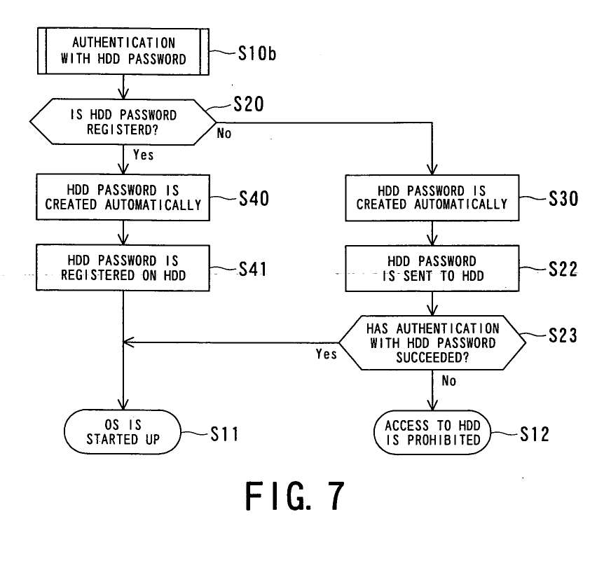

FIG. 7 is a flowchart of the processing in the information-processing apparatus 1 according to a third embodiment, showing only different processing, i.e., authentication with an HDD password (step S10b), from the processing shown in FIG. 4 illustrating the first embodiment.

The processing shown in FIG. 7 is different from the processing in the second embodiment in that steps S40 and S41 are added.

In the third embodiment, if no registered HDD password for the HDD 21 is present, the BIOS 22a automatically creates the HDD password (step S40), and registers the created HDD password in the HDD 21.

The process of creating the HDD password in step S40 is the same as that in step S30 (also the same as step S30 in FIG. 6 for the second embodiment).

In the third embodiment, after the authorized user registers the startup password, the HDD password is automatically registered in the HDD 21 (step S41) when the information-processing apparatus 1 is started for the first time.

According to the third embodiment, the same advantages as those in the first and second embodiments are realized. Additionally, even when an unauthorized person removes the HDD 21 from the information-processing apparatus 1 without turning on the power of the information-processing apparatus 1, since the HDD password registered in the HDD 21 in response to the initial startup performed by an authorized user is present, the unauthorized person cannot gain access to data stored in the HDD 21.

In the third embodiment, the HDD password is not manually registered by a user. Only automatic registration of the HDD password is carried out.

The present invention is not limited to the disclosed embodiments. The present invention is intended to cover various modifications and equivalent arrangements included within the spirit and scope of the appended claims. For example, some of the components shown in the disclosed embodiments may be omitted.

1. An information-processing apparatus having a first password, the information-processing apparatus comprising:
an input unit;
a storage unit;
means for authenticating an input password based on the first password, the input password being input through the input unit at startup of the information-processing apparatus;
means for determining whether a second password is present or not in the storage unit after the means for authenticating authenticates the input password;
means for generating the second password when the means for determining determines the second password is not to be present; and
means for storing the generated second password in the storage unit.

2. The information-processing apparatus according to claim 1: wherein the means for determining determines whether a second password is present or not in the storage unit when the authenticating the input password fails, and further comprising;
means for turning off power of the information-processing apparatus after the means for storing stores the generated second password in the storage unit.

3. The information-processing apparatus according to claim 2, further comprising:
means for unlocking protection using the second password, when an authentication performed by the means for authenticating succeeds with an input password which being input through the input unit at startup of the information-processing apparatus after the power of the information-processing apparatus is turned off by the means for turning off.

4. The information-processing apparatus according to claim 2, further comprising:
means for prompting a user to input a password which being input through the input unit at startup of the information-processing apparatus after the power of the information-processing apparatus is turned off by the means for turning off;
second means for authenticating the input password in response to a prompt performed by the means for prompting based on the generated second password; and
means for unlocking protection using the generated second password when an authentication performed by the second means for authenticating succeeds with the generated second password and the input password in response to the prompt performed by the means for prompting.

5. The information-processing apparatus according to claim 1, wherein the means for determining determines whether a second password is present or not in the storage unit when the authenticating the input password succeeds.

6. A method for starting an information-processing apparatus including an input unit and a storage unit, the apparatus having a first password, the method comprising:
authenticating an input password based on the first password, the input password being input through the input unit at startup of the information-processing apparatus;
determining whether a second password is present or not in the storage unit after authenticating the input password;
generating the second password if the second password is determined not to be present; and
storing the generated second password in the storage unit.

7. The method according to claim 6, wherein determining whether a second password is present or not in the storage unit when the authenticating the input password fails, and further comprising;
turning off power of the information-processing apparatus after storing the generated second password in the storage unit.

8. The method according to claim 7, further comprising:
unlocking protection using the second password, when an authentication succeeds with an input password which being input through the input unit at startup of the information-processing apparatus after the power of the information-processing apparatus is turned off.

9. The method according to claim 7, further comprising:
prompting a user to input a password which being input through the input unit at startup of the information-processing apparatus after the power of the information-processing apparatus is turned off;
authenticating the input password secondarily in response to a prompt based on the generated second password; and
unlocking protection using the generated second password when an authentication performed secondarily succeeds with the generated second password and the input password in response to the prompt.

10. The method according to claim 6, wherein determining whether a second password is present or not in the storage unit when the authenticating of the input password succeeds.

11. A program for starting an information-processing apparatus including an input unit and a storage unit, the apparatus having a first password, the program making a computer execute the steps of:
authenticating an input password based on the first password, the input password being input through the input unit at startup of the information-processing apparatus;
determining whether a second password is present or not in the storage unit after authenticating the input password;
generating the second password if the second password is determined not to be present; and
storing the generated second password in the storage unit.

12. The program according to claim 11, wherein determining whether a second password is present or not in the storage unit when the authenticating the input password fails, and the program further making a computer execute the step of:
turning off power of the information-processing apparatus after storing the generated second password in the storage unit.

13. The program according to claim 12, the program further making a computer execute the steps of:
unlocking protection using the second password, when an authentication succeeds with an input password which being input through the input unit at startup of the information-processing apparatus after the power of the information-processing apparatus is turned off.

14. The program according to claim 12, the program further making a computer execute the steps of:
prompting a user to input a password which being input through the input unit at startup of the information-processing apparatus after the power of the information-processing apparatus is turned off;
authenticating the input password secondarily in response to a prompt based on the generated second password; and
unlocking protection using the generated second password when an authentication performed secondarily succeeds with the generated second password and the input password in response to the prompt.

15. The program according to claim 11, wherein determining whether a second password is present or not in the storage unit when the authenticating of the input password succeeds.
